(19) United States
(12) Patent Application Publication
(10) Pub. No.: US 2004/0085867 A1
(43) Pub. Date: May 6, 2004

(54) Optical pickup unit and information recording and reproducing apparatus

(75) Inventors: Takayuki Sasaoka, Yokohama (JP); Noriyoshi Takeya, Yokohama (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Samsung Electro-Mechanics Co., Ltd.

(21) Appl. No.: 10/695,923

(22) Filed: Oct. 28, 2003

(30) Foreign Application Priority Data
Oct. 31, 2002 (JP) 2002-319057

(51) Int. Cl. G11B 7/095

(52) U.S. Cl. 369/44.29; 369/53.28

(57) ABSTRACT

Disclosed herein is an optical pickup unit and information recording and reproducing apparatus. The present invention provides an optical pickup unit which can store and maintain the characteristics of the optical pickup unit itself, and further provides an information recording and reproducing apparatus, which enables mass production without increasing costs even though optical pickup units having different characteristics are assembled, and enables maintenance to be easily performed without increasing costs. The optical pickup unit (10) of the present invention has an LD (11), an object lens (13) for focusing light emitted from the LD (11) on a disk, actuators (15 and 16) for driving the object lens (13) to vary the position of the object lens (13) relative to the disk, and a PD (14) for detecting light reflected from the disk. In addition, the optical pickup unit (10) has an EEPROM (18) for storing optical pickup information of the optical pickup unit (10) therein.

### FIELD OF THE INVENTION

The present invention relates generally to an optical pickup unit and information recording and reproducing apparatus, which reads information recorded on a recording medium, such as an optical disk or magneto-optical disk, or/and records information on a recording medium using laser light.

### DESCRIPTION OF THE PRIOR ART

Currently, phase change recording media and magneto-optical recording media are utilized as large-capacity information recording media capable of recording information with high density. For example, the phase change recording media are reproduction-only optical disks, recordable optical disks capable of being recorded with information, and rewritable optical disks capable of being erased and rewritten with information. Further, the magneto-optical recording media are basically capable of being erased and rewritten with information.

In order to read information recorded on any of the phase change recording media and the magneto-optical media and record information thereon, an optical pickup unit is used. As widely known in the art, an optical pickup unit is comprised of a laser light source, an object lens, a detector such as a PhotoDetector (PD), an actuator for driving the object lens and the like. The optical pickup unit focuses laser light emitted from the laser light source through the object lens to irradiate the laser light onto a recording surface of an information recording medium, and detects light reflected from the information recording medium through the detector. The optical pickup unit is mounted in the information recording and reproducing apparatus.

The information recording and reproducing apparatus comprises a tracking servo control system that controls laser light emitted from the optical pickup unit to accurately follow a certain track on an information recording medium on the basis of a detection signal output from the detector of the optical pickup unit, and a focus servo control system that controls spots of laser light to be arranged on a recording surface of the information recording medium regardless of the warped status of the information recording medium or the like.

At the time of reading information recorded on the information recording medium, reflection light, which can be obtained while spots of the laser light accurately follow the track on the recording surface of the information recording medium, is detected to read information recorded on the information recording medium, and the read information is reproduced by an information reproducing system. Further, at the time of recording information on an information recording medium, the emission of laser light with higher intensity than that used for reading is performed or stopped in response to a signal output from an information recording system while positions at which spots of laser light will be formed accurately follow the track on a recording surface of the information recording medium, thus recording information on the information recording medium. In this case, for tracking servo and focus servo systems installed in a conventional information reproducing apparatus, for example, Japanese Patent Laid-open Publication No. 7-82721 may be referred to.

However, different optical pickups rarely have the same characteristics and typically have different characteristics. In this case, the characteristics of the optical pickup represent the emission intensity of laser light, the detection sensitivity of a detector, Direct Current (DC) and Alternating Current (AC) characteristics of an actuator, and the like. In order to correct for differences in these characteristics between optical pickups, there is performed an adjusting operation, such as the adjustment of initial values of gains used in a tracking servo system, a focus servo system, an information reproducing system and an information recording system.

However, when a manufacturer assembles a number of information recording and reproducing apparatuses, an optical pickup unit having characteristics differing greatly from those of optical pickup units produced by each of other manufacturers can be assembled. In this case, there are required pains of changing all adjusted gain values according to the characteristics of the assembled optical pickup unit, and costs required to change the adjusted values increase. On the other hand, if the change of the adjustment is not carried out, the ranges of the output amplitudes of amplifiers in the information recording and reproducing apparatus cannot be effectively used, so the information recording and reproducing apparatus cannot perform adequately, such as by increasing the frequency of occurrence of tracking errors.

Moreover, the conventional information recording and reproducing apparatus is problematic in that, when an optical pickup unit requires replacement due to the inconvenience of reproduction and recording after a corresponding information recording and reproducing apparatus is produced, it is necessary to attach an optical pickup unit produced by the same manufacturer as that of the previous optical pickup unit. Accordingly, there are required pains to manage and replace parts, thus increasing maintenance costs. Further, the conventional information recording and reproducing apparatus is problematic in that, if the performance of an optical pickup unit is deteriorated due to aged deterioration caused by the gathering of dust on an object lens or the like, and a shifting of positions of optical parts from their installation positions, malfunctions such as the generation of noise occur, and, moreover, it takes much time to determine the causes of such malfunctions and perform maintenance.

### SUMMARY OF THE INVENTION

Accordingly, the present invention has been made keeping in mind the above problems occurring in the prior art, and an object of the present invention is to provide an optical pickup unit, which can store initial characteristics of the optical pickup unit itself therein, and an information recording and reproducing apparatus, which enables mass production without increasing costs even though optical pickup units having different characteristics are assembled, and enables maintenance to be easily performed without increasing costs.

In order to accomplish the above object, the present invention provides an optical pickup unit, comprising a light source (11), an optical device (13) for focusing light emitted from a corresponding light source on an information recording medium, drive devices (15 and 16) for driving the optical device to vary position of the optical device relative to the information recording medium, a detector (14) for detecting light reflected from the information recording medium, and a memory device (18) for storing optical pickup information of the optical pickup unit therein.

According to the present invention, since the optical pickup unit is equipped with a memory device for storing optical pickup information of the optical pickup unit therein, a quality control inspection of the optical pickup unit and the maintenance thereof can be carried out on the basis of the optical pickup information stored in the memory device, thus performing the quality control inspection and the maintenance without increasing costs.

In this case, the optical pickup information includes at least one of light emission characteristics of the light source, driving characteristics of the drive devices, production management information of the optical pickup unit, driving characteristics of the drive devices containing characteristics of a reproduction-only information recording medium, and driving characteristics of the drive devices containing characteristics of a recordable information recording medium.

In addition, the present invention provides an information recording and reproducing apparatus for performing at least one of functions of reproducing information recorded on an information recording medium and recording information thereon, comprising the optical pickup unit (10) of claim 1 or 2, detecting units (40 and 41) for detecting optical pickup information of the optical pickup unit (10), at least one of a writing unit (37) and an information reading unit (50), the writing unit (37) writing the optical pickup information detected by the detecting units in the memory device installed in the optical pickup unit, and the information reading unit (50) reading the optical pickup information written in the memory device installed in the optical pickup unit, at least one signal processing unit for executing predetermined processing for signals input/output to/from the optical pickup unit, and adjusting units (25 and 30) for adjusting parameters for the processing executed by the signal processing unit on the basis of the optical pickup information read by the information reading unit.

According to the present invention, since optical pickup information is read from the memory device installed in the optical pickup unit, and parameters for processing carried out by the signal processing units are adjusted on the basis of the optical pickup information, the processing parameters can be automatically adjusted according to the characteristics of the optical pickup unit. As a result, even though optical pickup units, produced by a plurality of manufacturers and having different characteristics, are assembled to produce the information recording and reproducing apparatus, the optical pickup units can be simply mounted in the information recording and reproducing apparatus, thus enabling mass production of the information recording and reproducing apparatus without increasing production costs.

Further, in the information recording and reproducing apparatus of the present invention, the signal processing unit comprises drive control units (21a to 23a, and 21b to 23b) for controlling the drive devices on the basis of a detection signal of the detector installed in the optical pickup unit as one processing, and an intensity adjusting unit (34) for adjusting intensity of light emitted from the light source installed in the optical pickup unit as another processing.

Moreover, in the information recording and reproducing apparatus, the optical pickup information includes at least one of light emission characteristics of the light source, driving characteristics of the drive devices, production management information of the optical pickup unit, driving characteristics of the drive devices containing characteristics of a reproduction-only information recording medium, and driving characteristics of the drive devices containing characteristics of a recordable information recording medium.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the construction of an optical pickup unit according to an embodiment of the present invention;

FIG. 2 is a block diagram partially showing the construction of a first information recording and reproducing apparatus according to a first embodiment of the present invention;

FIG. 3 is a flowchart showing the operation of detecting focusing and tracking DC characteristics of an optical pickup unit of FIG. 2;

FIG. 4 is a flowchart showing the operation of detecting focusing AC characteristics of the optical pickup unit of FIG. 2;

FIG. 5 is a flowchart showing the operation of detecting tracking AC characteristics of the optical pickup unit of FIG. 2;

FIG. 6 is a flowchart showing the operation of detecting the characteristics of a LD current and writing detected optical pickup information in an EEPROM;

FIG. 7 is a block diagram partially showing the construction of a second information recording and reproducing apparatus according to a second embodiment of the present invention; and

FIG. 8 is a flowchart of a process of setting initial values on the basis of the optical pickup information written in the EEPROM.

### DESCRIPTION OF THE PREFERRED EMBODIMENTS

Hereinafter, an optical pickup unit and information recording and reproducing apparatus according to embodiments of the present invention will be described in detail with reference to the attached drawings. In the embodiments which will described later, it is assumed that an information recording medium is a Compact Disk (CD, hereinafter referred to as disk), and there are described an optical pickup unit for reading information recorded on the disk and an information recording and reproducing apparatus for reproducing information read by the optical pickup unit as examples. Further, in the present invention, an information recording and reproducing apparatus may include an apparatus having one of a function of reproducing information recorded on an information recording medium and a function of recording information on an information recording medium, as well as apparatuses having both the functions.

### Optical Pickup Unit

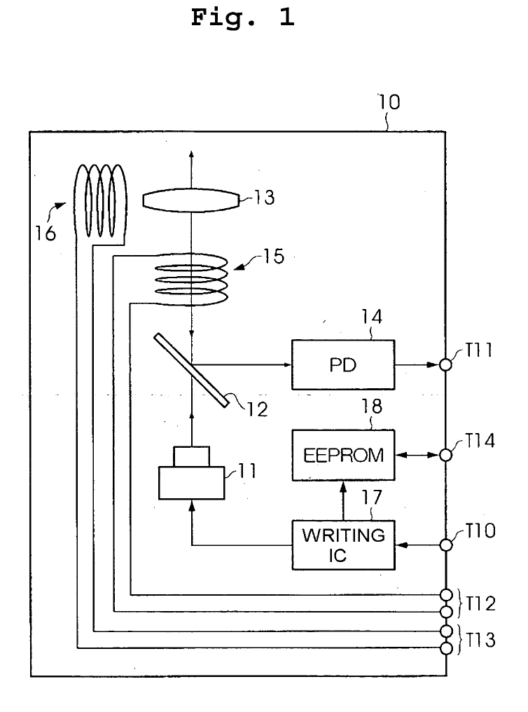

FIG. 1 is a block diagram showing the construction of an optical pickup unit according to an embodiment of the present invention. An optical pickup unit 10 comprises a Laser Diode (LD) 11 which is a light source, a half mirror 12, an object lens 13 which is an optical device, a Photodetector (PD) 14 which is a light detector, actuators 15 and 16 which are drive devices, a writing Integrated Circuit (IC) 17, and an Electrically Erasable Programmable Read-Only Memory (EEPROM) 18 which is a memory device.

The LD 11 is a semiconductor laser diode that emits laser light with a wavelength of, for example, 780nm, and the light emission of the LD 11 and the stopping thereof are controlled in response to a light emission control signal input through a terminal T10. Laser light emitted from the LD 11 reaches the object lens 13 through the half mirror 12 and is focused through the object lens 13. If the focused laser light is reflected from a disk (not shown), the reflection light reaches the half mirror 12 through the object lens 13 and is reflected from the half mirror 12, and then is detected by the PD 14. The detection signal of the PD 14 is output through a terminal T11.

The actuator 15 moves the object lens 13 in the direction of an optical axis of laser light (direction perpendicular to a recording surface of the disk) to perform focusing. The actuator 16 moves the object lens 13 in a direction orthogonal to the optical axis direction of the laser light (radial direction of the disk) to perform tracking. The distance the object lens 13 is moved by the actuator 15 is controlled in response to a focus control signal input from a terminal T12, and the distance the object lens 13 is moved by the actuator 16 is controlled in response to a tracking control signal input from a terminal T13.

If the information recording medium is a recordable optical disk (for example, CD-R) or rewritable optical disk (for example, CD-RW), the writing IC 17 controls the light emission of the LD 11 and the stopping thereof by generating a pulse signal according to input data so as to write the data input from the terminal T10. However, the writing IC 17 is not used when information recorded in a reproduction-only optical disk, such as a CD, is read.

The EEPROM 18 stores and maintains information of the optical pickup unit 10 (optical pickup information) therein. In this case, the optical pickup information represents arbitrary information of the optical pickup unit 10, for example, information on the characteristics of the optical pickup unit 10 (optical and electrical characteristics, etc.), production management information of the optical pickup unit 10 (production number, production date, production country, manufacturer and production line number), information on the driving time of the LD 11 and other information.

In the embodiment, LD current characteristics (light emission characteristics of a light source), focusing DC characteristics, tracking DC characteristics, focusing AC characteristics, and tracking AC characteristics (drive characteristics of a drive device) are exemplified as the optical pickup information. In this case, the LD current characteristics represent current values which must be provided to the LD 11 to obtain a laser output with certain intensity from the optical pickup unit 10 when information recorded on the disk is read.

Further, the focusing DC characteristics and the tracking DC characteristics represent voltage values which must be provided to the actuators 15 and 16, respectively, so as to move the object lens 13 in the direction of the optical axis of laser light or in the direction orthogonal to the optical axis direction by a certain distance. Further, the focusing AC characteristics and the tracking AC characteristics represent tracking performance of the object lens 13 obtained when an AC voltage with a certain frequency is applied to each of the actuators 15 and 16.

### Information Recording and Reproducing Apparatus According to First Embodiment

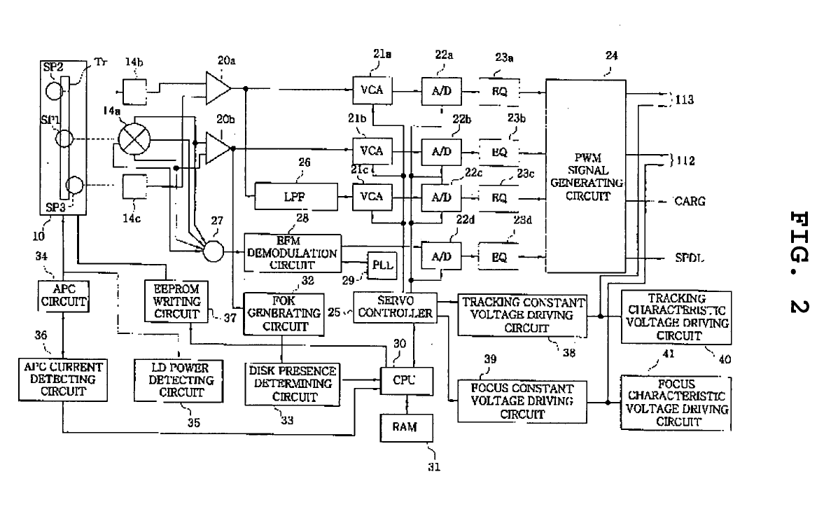

FIG. 2 a block diagram partially showing the construction of an information recording and reproducing apparatus according to a first embodiment of the present invention. In this case, FIG. 2 mainly illustrates a servo system of the information recording and reproducing apparatus, wherein the same reference numerals are used to designate components of FIG. 2 corresponding to components shown in FIG. 1. Further, for convenience of description, a photodetector 14 installed in the optical pickup unit 10 is depicted outside the optical pickup unit 10 in FIG. 2.

Referring to FIG. 2, Tr represents part of a track formed on a disk. As shown in FIG. 2, spots SP1 to SP3 are formed at three different points by laser light emitted from the optical pickup unit 10. The PD 14 is comprised of a four-division type PD 14a for detecting reflection light reflected from the spot SP1, a PD 14b for detecting reflection light reflected from the spot SP2, and a PD 14c for detecting reflection light reflected from the spot SP3. In this case, the spots SP1 and SP3 are used for performing tracking control based on a three-beam method.

Detection signals of the PDs 14b and 14c are input to an amplifier 20a, and a difference between the detection signals (tracking error signal) is obtained. The difference is amplified by a Voltage Control Amplifier (VCA) 21a by a certain amplification factor, and the amplified signal is converted to a digital signal by an Analog/Digital (A/D) converter 22a. The digital signal is output to a Pulse Width Modulation (PWM) signal generating circuit 24 through a digital Equalizer (EQ) 23a, and simultaneously output to a servo controller 25. Further, the output of the amplifier 20a is filtered by a Low Pass Filter (LPF) 26, and the filtered result is amplified by a VCA 21c by a certain amplification factor. The amplified signal is converted to a digital signal by an A/D converter 22c, and the digital signal is output to the PWM signal generating circuit 24 through an EQ 23c, and simultaneously output to the servo controller 25.

Further, signals A and B of the four-division type PD 14a are input to an amplifier 20b, and a difference between the two signals A and B (focus error signal) is obtained. The difference is amplified by a VCA 21b by a certain amplification factor, and the amplified signal is converted to a digital signal by an A/D converter 22b. The digital signal is output to the PWM signal generating circuit 24 through an EQ 23b, and simultaneously output to the servo controller 25.

Further, signals A to D of the four-division type PD 14a are added by an adder 27. The added signal is converted to an RF signal by a circuit consisting of an Eight to Fourteen Modulation (EFM) demodulation circuit 28 and a Phase Locked Loop (PLL) circuit 29, and is simultaneously converted to a digital signal by an A/D converter 22d. The digital signal is output to the PWM signal generating circuit 24 through an EQ 23d, and simultaneously output to the servo controller 25.

The PWM signal generating circuit 24 converts respective signals output from the EQs 23a to 23d to PWM signals. The output signal of the EQ 23a, converted to the PWM signal, is output to the terminal T13 of the optical pickup unit 10 as a tracking control signal. The output signal of the EQ 23b, converted to the PWM signal, is output to the terminal T12 of the optical pickup unit 10 as a focus control signal. The output signal of the EQ 23c, converted to the PWM signal, is output as a drive signal of a drive device (not shown) that moves the optical pickup unit 10 in the radial direction of the disk, and the output signal of the EQ 23d, converted to the PWM signal, is output as a drive signal of a spindle motor (not shown) that rotates the disk.

The servo controller 25 performs control operations, such as tracking control, focus control, and rotation control of the spindle motor, in response to signals output from the A/D converters 22a to 22d and a FOK signal output from a FOK (Focus OK) generating circuit 32, which will be described later, under the control of a Central Processing Unit (CPU) 30. Further, the servo controller 25 adjusts amplification factors of the VCAs 21a to 21c in response to the signals output from the A/D converters 22a to 22d under the control of the CPU 30. A Random Access Memory (RAM) 31 temporarily stores therein information, such as amplification factors set by the VCAs 21a to 21c.

Further, the FOK generating circuit 32 outputs the FOK signal, indicating whether a focal point of the optical pickup unit 10 is positioned on a recording surface of the disk, to both the servo controller 25 and a disk presence determining circuit 33 on the basis of a signal output from the amplifier 20b. The disk presence determining circuit 33 determines whether a disk is seated on the information recording and reproducing apparatus on the basis of the FOK signal, and outputs the determination result to the CPU 30.

An Auto Power Control (APC) circuit 34 is a circuit that drives the LD 11 depending on the detection result of an LD power detecting circuit 35 such that laser light emitted from the LD 11 has certain intensity at the time of reproducing (or recording) information. An APC current detecting circuit 36 detects a current flowing through the LD 11 under the control of the APC circuit 34, and outputs the detection result to the CPU 30. An EEPROM writing circuit 37 writes optical pickup information, such as the LD current characteristics, the focusing and tracking DC characteristics, and the focusing and tracking AC characteristics, in the EEPROM 18 installed in the optical pickup unit 10. In this case, the EEPROM writing circuit 37 corresponds to a writing unit referred in the present invention.

A tracking constant voltage driving circuit 38 drives the object lens 13 by applying a constant voltage to the actuator 16 under the control of the servo controller 25. A focus constant voltage driving circuit 39 drives the object lens 13 by applying a constant voltage to the actuator 15 under the control of the servo controller 25. A tracking characteristic detecting circuit 40 detects the focal point of the object lens 13 in the direction orthogonal to the optical axis of the object lens 13 when the constant voltage is applied to the actuator 16 by the tracking constant voltage driving circuit 38.

Further, a focus characteristic detecting circuit 41 detects the focal point of the object lens 13 in the direction of the optical axis of the object lens 13 when the constant voltage is applied to the actuator 15 by the focus constant voltage driving circuit 39. The results detected by both the tracking characteristic detecting circuit 40 and the focus characteristic detecting circuit 41 are output to the CPU 30.

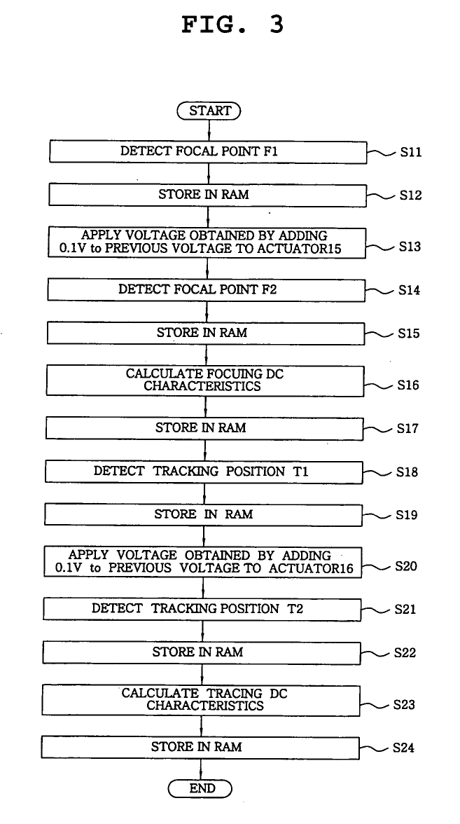

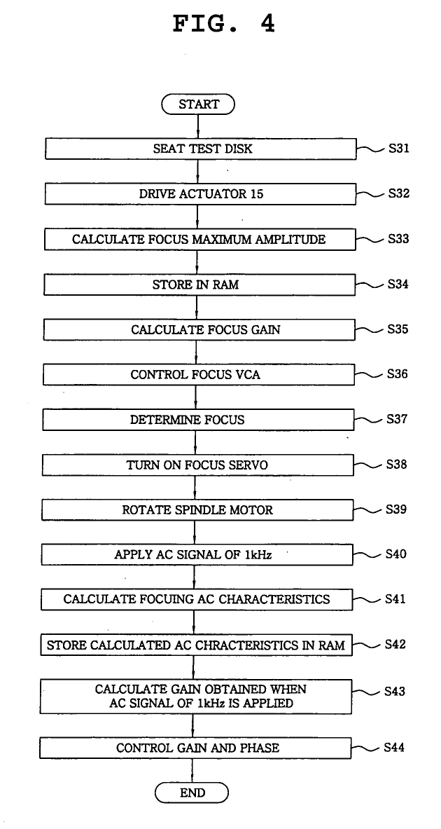

In the information recording and reproducing apparatus having the above construction, the operations of detecting optical pickup information and writing the optical pickup information in the EEPROM 18 provided in the optical pickup unit 10 are described. FIGS. 3 to 6 are flowcharts showing the operations of detecting optical pickup information and writing the optical pickup information in the EEPROM 18 provided in the optical pickup unit 10. In this case, FIGS. 3 and 4 illustrate flowcharts showing the operations performed when optical pickup information of the optical pickup unit 10 is detected using, for example, the information recording and reproducing apparatus shown in FIG. 2, as an inspecting apparatus at the time of inspecting the produced optical pickup unit 10, and the optical pickup information is written in the EEPROM 18 of the optical pickup unit 10.

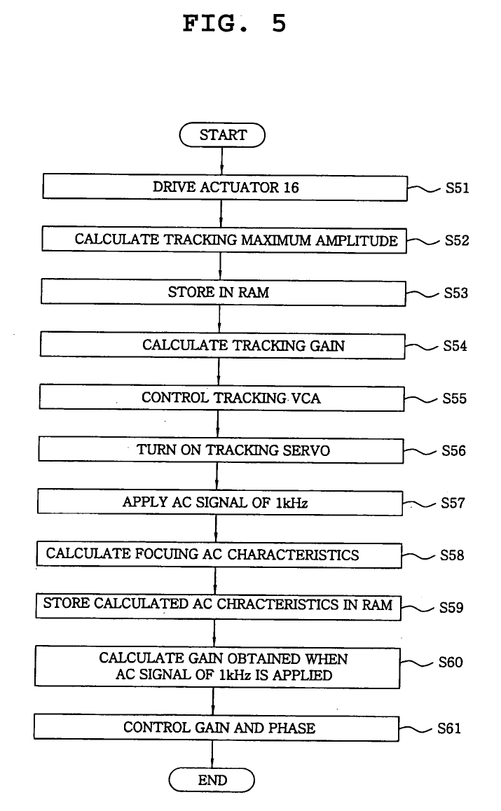

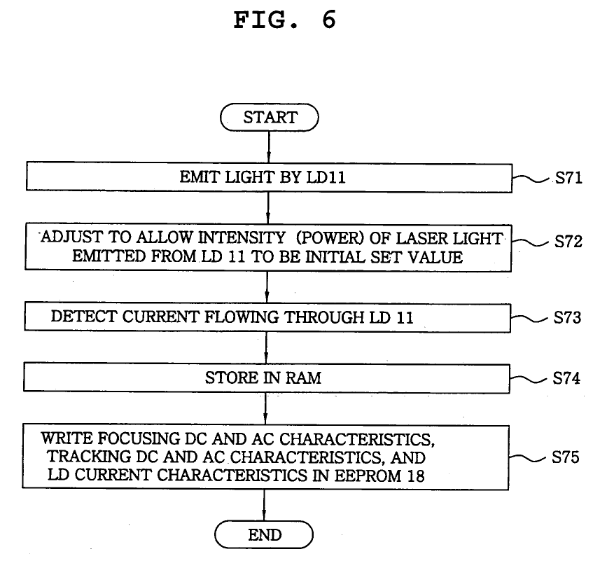

FIG. 3 is a flowchart showing the operation of detecting focusing and tracking DC characteristics of the optical pickup unit 10, FIG. 4 is a flowchart showing the operation of detecting focusing AC characteristics of the optical pickup unit 10, FIG. 5 is a flowchart showing the operation of detecting tracking AC characteristics of the optical pickup unit 10, of FIG. 2, and FIG. 6 is a flowchart showing the operation of detecting LD current characteristics and writing the detected optical pickup information in the EEPROM 18.

Referring to FIG. 3, the operation of detecting the focusing and tracking DC characteristics of the optical pickup unit 10 is described. An optical pickup unit, which has been completely produced and adjusted, is attached to the information recording and reproducing apparatus. Next, the servo controller 25 outputs a certain voltage to the focus constant voltage driving circuit 39 under the control of the CPU 30. The voltage is applied to the actuator 15 through the terminal T12, so the object lens 13 is moved along the optical axis by a distance corresponding to the voltage applied to the actuator 15.

In this state, the focus characteristic detecting circuit 41 detects a focal point F1 of the optical pickup unit 10 at step S11. The detection of the focal point of the optical pickup unit 10 is carried out using a detection method, such as a laser drop method, or a photocoupler (not shown). After the detection of the focal point F1 has been completed, the detection result is output to the CPU 30, and the CPU 30 stores the detection result in the RAM 31 at step S12.

Next, the servo controller 25 controls the focus constant voltage driving circuit 39 to output to the actuator 15 a voltage obtained by adding a voltage, for example, 0.1V, to the voltage which has been previously applied to the actuator 15 at the time of detecting the focal point F1 at step S13. Further, the focus characteristic detecting circuit 41 detects a focal point F2 of the optical pickup unit 10 at step S14, and the CPU 30 stores the detection result in the RAM 31 at step S15. After the above process has been completed, the CPU 30 calculates the focusing DC characteristics by subtracting the focal point F1 from the focal point F2 stored in the RAM 31 at step S16, and stores the focusing DC characteristics in the RAM 31 at step S17.

Similar to this, the servo controller 25 outputs a certain voltage to the tracking constant voltage driving circuit 38 under the control of the CPU 30. The voltage is applied to the actuator 16 through the terminal T11, so the object lens 13 is moved in the direction orthogonal to the optical axis by a distance corresponding to the voltage applied to the actuator 16. In this state, the tracking characteristic detecting circuit 40 detects a tracking position T1 of the optical pickup unit 10 at step S18. In this case, the detection of the tracking position of the optical pickup unit 10 is carried out using a detection method, such as a laser drop method, or a photocoupler (not shown) in the same manner as the detection of the focal points.

After the detection of the tracking position T1 has been completed, the CPU 30 stores the detection result in the RAM 31 at step S19. Next, the tracking constant voltage driving circuit 38 outputs to the actuator 16 a voltage obtained by adding a voltage, for example, 0.1V, to the voltage which has been previously applied to the actuator 16 at step S20. Further, the tracking characteristic detecting circuit 40 detects a tracking position T2 of the optical pickup unit 10 at step S21, and the CPU 30 stores the detection result in the RAM 31 at step S22.

After the above process has been completed, the CPU 30 calculates the tracking DC characteristics by subtracting the tracking position T1 from the tracking position T2 stored in the RAM 31 at step S23, and stores the tracking DC characteristics in the RAM 31 at step S24. Through the above process, the focusing and tracking DC characteristics of the optical pickup unit 10 are detected, and the detection results are stored in the RAM 31.

Next, referring to FIG. 4, the operation of detecting the focusing AC characteristics of the optical pickup unit 10 is described. At the time of detecting the focusing AC characteristics, a test disk is seated on the information recording and reproducing apparatus at step S31. If the test disk is seated, the servo controller 25 drives the actuator 15 by outputting a drive signal to the focus constant voltage driving circuit 39, and reciprocates the object lens 13 along the optical axis by the predetermined number of times at step S32.

Accordingly, a S-curve signal is output as a focus error signal from the amplifier 20b. The CPU 30 obtains the maximum amplitude of the S-curve signal using a calculation on the basis of a signal output from the A/D converter 22b through the servo controller 25 at step S33, and stores the maximum amplitude in the RAM 31 at step S34. Further, the CPU 30 obtains a gain (focus gain) of the VCA 21b from the maximum amplitude of the S-curve signal using a calculation so as to effectively use a dynamic range of the A/D converter 22b at step S35, and sets the obtained gain by the VCA 21b to perform focus control at step S36.

Next, while the focus control is performed, it is determined whether the optical pickup unit 10 is focused on the test disk on the basis of the signal output from the A/D converter 22b and the FOK signal output from the FOK generating circuit 32 at step S37. The focus servo system is operated in a closed loop manner at step S38. After the above process has been completed, the servo controller 25 rotates the spindle motor (not shown) by outputting a drive signal to the A/D converter 22d at step S39. The servo controller 25 generates an AC signal which is a bandwidth of the focus servo system, for example, a sine wave signal of 1 KHz and applies the AC signal to the focus servo system through the focus constant voltage driving circuit 39 at step S40.

In this state, the focus characteristic detecting circuit 41 obtains focusing AC characteristics from the focus error signal output from the amplifier 20b through both the A/D converter 22b and the servo controller 25 using a calculation at step S41, and the CPU 30 stores the calculation result in the RAM 31 at step S42. Further, the CPU 30 calculates a gain obtained when the AC signal is applied at step S43, and controls the gain and phase of the EQ 23b such that the calculated gain becomes a design target gain at step S44. Through the above process, the focusing AC characteristics of the optical pickup unit 10 are detected, and the detected results are stored in the RAM 31.

Referring to FIG. 5, the operation of detecting tracking AC characteristics of the optical pickup unit 10 is described. At the time of detecting the tracking AC characteristics, after the test disk is seated on the information recording and reproducing apparatus, the servo controller 25 moves the optical pickup unit 10 in the radial direction of the disk by a certain distance by outputting a drive signal to a driving circuit (not shown), and simultaneously drives the actuator 16 by outputting a drive signal to the tracking constant voltage driving circuit 38 and moves the object lens 13 in the direction orthogonal to the optical axis direction (that is, radial direction of the disk) at step S51.

The object lens 13 is moved to allow the tracking error signal to be output from the amplifier 20a. The CPU 30 obtains the maximum amplitude of the tracking error signal using a calculation on the basis of a signal output from the AID converter 22a through the servo controller 25 at step S52, and stores the maximum amplitude in the RAM 31 at step S53.

Further, the CPU 30 obtains a gain (tracking gain) of the VCA 21a from the maximum amplitude of the tracking error signal using a calculation so as to effectively use a dynamic range of the A/D converter 22a at step S54, and sets the obtained gain by the VCA 21a to perform a control operation at step S55. Further, after the balance of the tracking error signal is adjusted, a tracking servo system is operated in a closed loop manner at step S56.

In this state, the servo controller 25 generates an AC signal which is a bandwidth of the tracking servo system, for example, a sine wave signal of 1 KHz, and applies the AC signal to the tracking servo system through the tracking constant voltage driving circuit 38 at step S57. In this case, the tracking characteristic detecting circuit 40 obtains tracking AC characteristics from the signal output from the amplifier 20a through both the A/D converter 22a and the servo controller 25 using a calculation at step S58, and the CPU 30 stores the calculation result in the RAM 31 at step S59. Further, the CPU 30 calculates a gain obtained when the AC signal is applied at step S60, and controls the gain and phase of the EQ 23a such that the calculated gain becomes a design target gain at step S61. Through the above process, the tracking AC characteristics of the optical pickup unit 10 are detected, and the detected results are stored in the RAM 31.

Referring to FIG. 6, there is described the operation of detecting LD current characteristics of the optical pickup unit 10 and writing the focusing DC and AC characteristics, tracking DC and AC characteristics, and the LD current characteristics in the EEPROM 18 provided in the optical pickup unit 10. First, the LD 11 emits laser light through the APC circuit 34 at step S71. After that, a variable resistor (not shown) installed in the optical pickup unit 10 is adjusted with reference to the detection result of the LD power detecting circuit 35 such that the intensity (power) of the laser light emitted from the LD 11 becomes an initial value set when the optical pickup unit 10 is delivered (for example, the power of laser light output through the object lens 13 is 0.5 mW) at step S72.

After the adjustment has been completed, a current flowing through the LD 11 is detected using the APC current detecting circuit 36 under the control of the APC circuit 34 at step S37. The detection result is output to the CPU 30 and stored in the RAM 31 at step S74. After the above process has been completed, the CPU 30 reads the focusing is DC and AC characteristics, the tracking DC and AC characteristics and the LD current characteristics stored in the RAM 31 and outputs the read characteristics to the EEPROM writing circuit 37.

The EEPROM writing circuit 37 writes the information output from the CPU 30 in the EEPROM 18 installed in the optical pickup unit 10. When the information is written in the EEPROM 18, the information is preferably recorded in a storage device (not shown) installed in the information recording and reproducing apparatus, or external recording device (not shown), such as a hard disk, an optical disk and other information recording media.

Hereinbefore, the information recording and reproducing apparatus according to the first embodiment of the present invention is described. In the above embodiment, the focusing DC and AC characteristics, the tracking DC and AC characteristics, and the LD current characteristics are written together in the EEPROM 18 at the last stage of the process, but the timing of the writing of the characteristics is not limited to the first embodiment. For example, after each characteristic information is obtained, it can be written at any time. In this embodiment, an example in which a disk for reproduction is used as the test disk is described, but one of a CD-R (recordable) and a CD-RW (rewritable) which are recordable CDs, or both of them can be used as the test disk to write respective DC and AC characteristics in the EEPROM 18.

### Information Recording and Reproducing Apparatus According to Second Embodiment

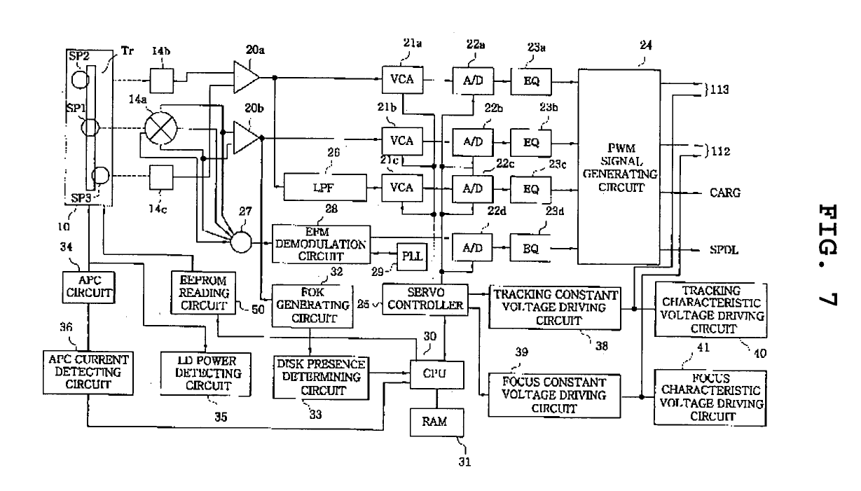

FIG. 7 is a block diagram partially showing the construction of a second information recording and reproducing apparatus according to a second embodiment of the present invention. In this case, a servo system of the information recording and reproducing apparatus is mainly depicted in FIG. 7 in the same manner as FIG. 2. The same reference numerals are used to designate components of FIG. 7 corresponding to components shown in FIG. 2. Further, for convenience of description, a photodetector (PD) 14 installed within the optical pickup unit 10 is depicted outside the optical pickup unit 10, the same as the first embodiment.

The information recording and reproducing apparatus according to the second embodiment of the present invention of FIG. 7 is almost the same as the first embodiment of FIG. 2 in basic construction. However, the first and second embodiments are different in that an EEPROM reading circuit 50 is provided as an information reading unit in the second embodiment of FIG. 7, instead of the EEPROM writing circuit 37 shown in FIG. 2. That is, in the above-described first embodiment, optical pickup information of the produced optical pickup unit 10 is detected and written in the EEPROM 18, but, in the second embodiment, an optical pickup unit equipped with the EEPROM 18 in which optical pickup information is written is provided in advance, and thereafter information recorded on a disk is reproduced (and information is recorded on the disk).

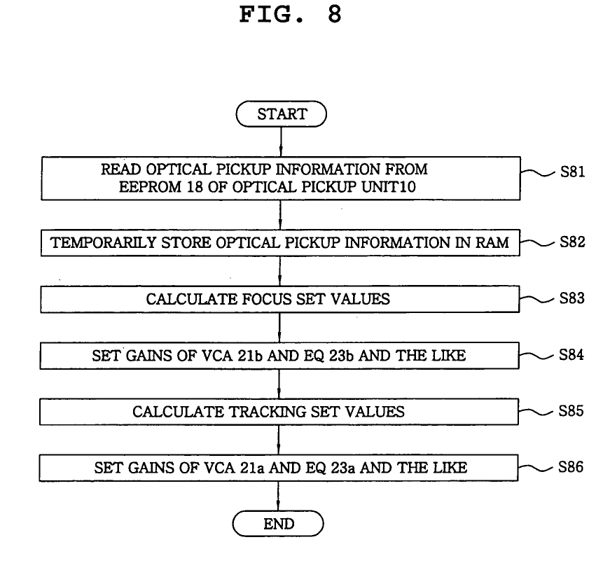

The information recording and reproducing apparatus having the construction of FIG. 7 reads optical pickup information written in the EEPROM 18 installed in the optical pickup unit 10 through the EEPROM reading circuit 50 and sets initial values, such as gains of VCAs 21a and 21b, on the basis of the optical pickup information. Hereinafter, this operation is described. FIG. 8 is a flowchart of a process of setting initial values on the basis of the optical pickup information written in the EEPROM 18. In this case, the process shown in FIG. 8 is preferably carried out when power is supplied to the information recording and reproducing apparatus or when a disk is changed.

When the process starts, the CPU 30 outputs a control signal to the EEPROM reading circuit 50. Upon receiving the control signal, the EEPROM reading circuit 50 reads optical pickup information written in the EEPROM 18 installed in the optical pickup unit 10 and outputs the read optical pickup information to the CPU 30 at step S81. If the optical pickup information is output from the EEPROM reading circuit 50, the CPU 30 temporarily stores the optical pickup information in the RAM 31 at step S82.

Next, the CPU 30 reads the focusing DC and AC characteristic information among the optical pickup information stored in the RAM 31, and calculates set values, such as gains to be set by the VCA 21b and the EQ 23b, at step S83, and sets the values by the VCA 21b and the EQ 23b at step S84. Next, the CPU 30 reads tracking DC and AC characteristic information among the optical pickup information stored in the RAM 31, and calculates set values, such as gains to be set by the VCA 21a and the EQ 23a, at step S85, and sets the values by the VCA 21a and the EQ 23a at step S86.

As described above, in the embodiment of the present invention, the optical pickup information representing initial performance of the optical pickup unit 10 is read from the EEPROM 18, and control parameters for control systems in the focus and tracking servo systems are set on the basis of the optical pickup information. Accordingly, the control parameters for control systems are automatically set to correspond to the characteristics of the optical pickup unit 10. Even though optical pickup units having different characteristics, produced by a plurality of manufacturers, are assembled, the optical pickup units can be easily mounted in the information recording and reproducing apparatus.

As a result, the optical pickup units having different characteristics can be mounted even in the same kinds of information recording and reproducing apparatuses, thus enabling mass production of the information recording and reproducing apparatuses to be achieved without increasing costs. Further, even though an optical pickup unit is changed for maintenance, optical pickup units having different characteristics can be mounted, thus easily performing maintenance without increasing costs.

Moreover, a manufacturer of the optical pickup unit 10 has the same information as the optical pickup information written in the EEPROM 18. Therefore, for example, if a manufacturer of the optical pickup unit 10 delivers the optical pickup unit 10 to a manufacturer of the information recording and reproducing apparatus, it can be easily checked at a low cost whether the characteristics of the optical pickup unit 10 have changed during shipping. Further, since optical pickup information, representing characteristics of each optical pickup unit 10, is stored in each optical pickup unit 10, a random inspection before the delivery of the optical pickup unit 10 can be carried out using the optical pickup information, thus reducing costs required for inspection.

In the above embodiments, an information recording and reproducing apparatus that reproduces information recorded on a disk which is an information recording medium is mainly described as an example, but the present invention can also be applied to an information recording and reproducing apparatus having a function of recording information on a disk. In such an information recording and reproducing apparatus, it is preferable to separately write various control parameters for reproduction and various control parameters for recording in the EEPROM 18 and use the parameters. For example, control parameters for reproduction and recording can be LD current characteristics obtained at the time of reproduction and recording, respectively. Further, it is very preferable to write optimal emission power level of the LD 11 at the time of recording in the EEPROM 18 and control the emission power of the LD 11 to be the optimal emission power. In this case, the APC circuit 34 performs a function corresponding to an intensity adjusting unit of the present invention. Further, it is very preferable to use recordable CDs, that is, CD-R and/or CD-RW as the test disk and write focusing and tracking AC characteristics corresponding to each disk as recording characteristics.

Further, in the embodiment, there are separately described the information recording and reproducing apparatus having the function of writing optical pickup information in the EEPROM 18, and the information recording and reproducing apparatus having the function of reading optical pickup information recorded in the EEPROM 18 to set control parameters. However, an information recording and reproducing apparatus having both the functions can be provided. In such an apparatus, it is preferable to write use conditions of the LD 11 (emission time of laser light at the time of reproduction and emission time of laser light at the time of recording) in the EEPROM 18. The above-described operations are performed, such that a time to change the optical pickup unit 10 can be recognized and the maintenance of the information recording and reproducing apparatus can be suitably carried out.

As described above, the present invention provides an optical pickup unit and information recording and reproducing apparatus, in which the optical pickup unit is equipped with a memory device for storing optical pickup information of the optical pickup unit therein, a quality control inspection of the optical pickup unit and the maintenance thereof can be carried out on the basis of the optical pickup information stored in the memory device, thus performing the quality control inspection and the maintenance without increasing costs.

Further, the present invention is advantageous in that, since optical pickup information is read from the memory device installed in the optical pickup unit, and parameters for processing carried out by the signal processing units are adjusted on the basis of the optical pickup information, the processing parameters can be automatically adjusted according to the characteristics of the optical pickup unit. As a result, even though optical pickup units, produced by a plurality of manufacturers and having different characteristics, are assembled to produce the information recording and reproducing apparatus, the optical pickup units can be simply mounted in the information recording and reproducing apparatus, thus enabling mass production of the information recording and reproducing apparatus without increasing production costs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical pickup unit, comprising:
at least one light source;
an optical device for focusing light emitted from a corresponding light source on an information recording medium;
one or more drive devices for driving the optical device to vary position of the optical device relative to the information recording medium;
a detector for detecting light reflected from the information recording medium; and
a memory device for storing optical pickup information of the optical pickup unit therein.

2. The optical pickup unit according to claim 1, wherein the optical pickup information includes at least one of light emission characteristics of the light source, driving characteristics of the drive devices, production management information of the optical pickup unit, driving characteristics of the drive devices containing characteristics of a reproduction-only information recording medium, and driving characteristics of the drive devices containing characteristics of a recordable information recording medium.

3. An information recording and reproducing apparatus for performing at least one of functions of reproducing information recorded on an information recording medium and recording information thereon, comprising:
the optical pickup unit of claim 2;
one or more detecting units for detecting optical pickup information of the optical pickup unit;
at least one of a writing unit and an information reading unit, the writing unit writing the optical pickup information detected by the detecting units in the memory device installed in the optical pickup unit, and the information reading unit reading the optical pickup information written in the memory device installed in the optical pickup unit,
at least one signal processing unit for executing predetermined processing for signals input/output to/from the optical pickup unit; and
one or more adjusting units for adjusting parameters for the processing executed by the signal processing unit on the basis of the optical pickup information read by the information reading unit.

4. The information recording and reproducing apparatus according to claim 3, wherein the signal processing unit comprises:
one or more drive control units for controlling the drive devices on the basis of a detection signal of the detector installed in the optical pickup unit as one processing; and
an intensity adjusting unit for adjusting intensity of light emitted from the light source installed in the optical pickup unit as another processing.

5. The information recording and reproducing apparatus according to claim 4, wherein the optical pickup information includes at least one of light emission characteristics of the light source, driving characteristics of the drive devices, production management information of the optical pickup unit, driving characteristics of the drive devices containing characteristics of a reproduction-only information recording medium, and driving characteristics of the drive devices containing characteristics of a recordable information recording medium.

6. An information recording and reproducing apparatus for performing at least one of functions of reproducing information recorded on an information recording medium and recording information thereon, comprising:
the optical pickup unit of claim 2;
one or more detecting units for detecting optical pickup information of the optical pickup unit;
at least one of a writing unit and an information reading unit, the writing unit writing the optical pickup information detected by the detecting units in the memory device installed in the optical pickup unit, and the information reading unit reading the optical pickup information written in the memory device installed in the optical pickup unit,
at least one signal processing unit for executing predetermined processing for signals input/output to/from the optical pickup unit; and
one or more adjusting units for adjusting parameters for the processing executed by the signal processing unit on the basis of the optical pickup information read by the information reading unit.

7. The information recording and reproducing apparatus according to claim 6, wherein the signal processing unit comprises:
one or more drive control units for controlling the drive devices on the basis of a detection signal of the detector installed in the optical pickup unit as one processing; and
an intensity adjusting unit for adjusting intensity of light emitted from the light source installed in the optical pickup unit as another processing.

8. The information recording and reproducing apparatus according to claim 7, wherein the optical pickup information includes at least one of light emission characteristics of the light source, driving characteristics of the drive devices, production management information of the optical pickup unit, driving characteristics of the drive devices containing characteristics of a reproduction-only information recording medium, and driving characteristics of the drive devices containing characteristics of a recordable information recording medium.
